(19) United States
(12) Patent Application Publication
(10) Pub. No.: US 2003/0076461 A1
(43) Pub. Date: Apr. 24, 2003

(54) Liquid crystal on silicon incorporating integrated spacers and silicon light valves and method for fabrication

(75) Inventors: Hong-Da Liu, Hsinchu (TW); Yong-Nien Rao, Hsinchu (TW)

Correspondence Address: TUNG & ASSOCIATES, Suite 120, 838 W. Long Lake Road, Bloomfield Hills, MI, 48302, US

(73) Assignee: Industrial Technology Research Institute

(21) Appl. No.: 10/032,523

(22) Filed: Oct. 19, 2001

(51) Int. Cl. G02F 1/1335

(52) U.S. Cl. 349/113

(57) ABSTRACT

A liquid crystal on silicon structure that incorporates integrated spacers and silicon light valves and a method for such fabrication are disclosed. The structures includes a silicon substrate that has a multiplicity of pixel electrodes formed on a top surface. A multiplicity of integrated spacers formed of an insulating materials on the top surface of the silicon substrate in-between the multiplicity of pixel electrodes, and a multiplicity of silicon light valves formed on a top surface of the silicon substrate for orienting liquid crystal molecules. A glass substrate that is optically transparent with an optically transparent electrode layer on a bottom surface is positioned juxtaposed to and over the silicon substrate supported by the integrated spacers to form a sealed cavity by engaging a perimeter seal surrounding the two substrates. A liquid crystal is used to fill the sealed cavity forming the present invention liquid crystal on silicon structure.

### FIELD OF THE INVENTION

The present invention generally relates to a liquid crystal on silicon structure and a method for fabrication and more particularly, relates to a liquid crystal on silicon structure that incorporates integrated spacers and silicon light valves and a method for fabricating such structure.

### BACKGROUND OF THE INVENTION

Liquid crystal display devices have been used for many years. In the beginning, their uses have been concentrated in small appliance applications such as electronic watches and calculators. LCD's are now used in applications for instrument panel numerical displays and graphical displays. Advantages presented by LCD's are their inherent properties of small thickness, lightweight, low driving voltage required and low power consumption. As a consequence, more recent applications of color LCD's can be found in small screen television sets, notebook computer display panels and video camera view finders as replacements for conventional CRT's.

A liquid crystal display device can be made either a color unit or a black and white unit. The device may also be constructed as a reflective-type or as a transmissive type, depending on the light source used. Since liquid crystal molecules respond to an externally applied electrical voltage, liquid crystals can be used as an optical switch or as a light valve. A typical liquid crystal display cell arrangement is shown in FIGS. 1A and 1B.

Referring initially to FIG. 1A, wherein a liquid crystal display device 10 is shown. Liquid crystal display cell 10 is a single pixel which is constructed by two parallel glass plates, i.e., an upper plate 12 and a lower plate 14. Both the upper plate 12 and the lower plate 14 have a polarizing film 36 and 32 coated on its outer surface. The cavity 18 formed between the two plates 12 and 14 is filled with a liquid crystal material 20. One of the most commonly used liquid crystal material is of the twisted nematic (TN) type wherein the term twist refers to the tendency of the liquid crystal to form chains that rotate from one side 22 of the gap between the plates to the other side 24 of the gap. The degree of rotation can be controlled during the fabrication process.

As shown in FIG. 1A, light beam 28 passes through the polarizer 36 and then through the liquid crystal display cell 10 having its polarization direction rotated by following the physical rotation of the liquid crystal molecules 26. As shown in this simplified illustration, the polarizer 32 on the exit side 24 of the liquid crystal cell 10 is positioned such that it allows a rotated light beam 30 to pass through the polarizer 32. When viewed from the side of the polarizer 32, the pixel of the liquid crystal cell 10 thus appears clear, i.e. in a transmitting mode.

A transparent electrical conductor (not shown) such as indium-tin-oxide (ITO) is normally deposited on the inner surfaces of the glass plates 12 and 14. When a voltage is applied across the cell cavity 18 by addressing an appropriate line formed on each side of the cell, the liquid crystal molecules 26 reorient themselves to follow the applied electric field. The liquid crystal materials 26 are thus untwisted as shown in FIG. 1B. The passage of the untwisted light beam 34 is blocked by the exit polarizer 32 as long as the voltage is present. When the voltage is turned off (shown in FIG. 1A), the liquid crystal molecules 26 returns to their original state and the cell or the pixel becomes clear again. As previously stated, typical voltages and currents required to activate the liquid crystal molecules are relatively low making it an ideal candidate for incorporation in battery-operated equipment where low power consumption is essential. A typical twisted nematic (TN) liquid crystal cell used for small displays have a twist angle of 90°. More recently developed super-twisted nematic (STN) material forms a twist angle up to 270° and thus allow higher contrast so that many pixel elements can be multiplexed in a single display.

More recently, liquid crystal on silicon (LCOS) structures have been developed as a more advanced form of liquid crystal display devices. One of the benefits of the LCOS structure is that major steps of the fabrication process can be integrated into the semiconductor fabrication technologies. However, the traditional fabrication method for the liquid crystal on silicon structure has several processing problems that leads to quality issues and low yield. For instance, as shown in FIGS. 2A and 2B, in a conventional liquid crystal on silicon device 40 which is built in-between a silicon substrate 42 and a glass substrate 44. A voltage is applied to the polarizer films (not shown) on the two substrates. In order to maintain a suitable gap between the two substrates 42, 44, a spacer spraying process is utilize to plant spacers 46 in-between the two substrates. The spacers 46 utilized has a dimension such as a diameter between about 4 μm and about 6 μm which are lodged in-between the two substrates. Since the normal pixel size is in the range of 5 μm˜20 μm, the spacers 46 occupy a significant space in-between the two substrates. This is shown in FIG. 2A.

Surrounding the spacer particles 46, the liquid crystal molecules 48 tend to align with the spacer particles 46, instead of the normal liquid crystal molecules 50 which would align in a direction that is perpendicular to the substrates 42,44. The mis-aligned molecules cause a leakage of light in the pixel, as shown in FIG. 2B. A further problem caused by the spacer particles is that non-uniform compression between the two substrates can be caused by the presence of the spacer particles 46. In order to eliminate the non-uniform compression, the silicon substrate, or the silicon wafer needs to be polished by a chemical mechanical polishing process prior to bonding to the glass substrate. This additional polishing process further contributes to the fabrication cost of the liquid crystal on silicon.

In a conventional liquid crystal on silicon structure 52, shown in FIGS. 3A, an integrated spacer 54 may also be used for forming the gap between the top and the bottom substrate. The integrated spacer 54, may be formed by a photoresist material that can be patterned by a photolithographic process. When the integrated spacer 54 is formed on a top surface 56 of the bottom substrate 58, i.e. when a bottom silicon substrate is assembled to a top glass substrate, a thin polymeric film is deposited on each substrate for providing orientation of the liquid crystal molecules. The orientation film is usually a hard polymeric material such as one formed of polyimide. After the orientation film is deposited and cured, it is rubbed with a fabric in a predetermined direction for forming shallow grooves in the surface of the orientation film. The surface grooves guide the liquid crystal molecules to an alignment at the substrate surface to assume a proper tilt or twist angle. For instance, in a super-twist liquid crystal cell, a high tilt angle is used to provide a high twist of up to 270°.

When the rubbing process is carried out on a cloth mounted on a belt, the cloth may cause scratch marks 62 on the top surface of the silicon wafer. The scratch marks produce a reverse tilt, or a reverse twist in the liquid crystal molecules 60 shown in FIG. 3B. Reverse twist domains are thus produced leading to a low aperture rate, or a low brightness of the liquid crystal cell. The rubbing process for orientation should thus be eliminated in order to avoid the defect in liquid crystal. When the reverse tilt or the reverse twist defect occurs, region of the reverse tilt may be as wide as 3 μm˜8 μm which requires the use of a black matrix film in order to block light leakage at the reverse tilt region.

It is therefore an object of the present invention to provide a liquid crystal on silicon structure that does not have the drawbacks or shortcomings of the conventional liquid crystal on silicon structure.

It is another object of the present invention to provide a liquid crystal on silicon structure that does not require a spacer spraying process for laying down spacer in-between two substrates.

It is a further object of the present invention to provide a liquid crystal on silicon structure that does not require the use of large size spacers.

It is another further object of the present invention to provide a liquid crystal on silicon structure that does not require a rubbing process for orienting the liquid crystal molecules.

It is still another object of the present invention to provide a liquid crystal on silicon structure that does not have the reverse tilt liquid crystal defects caused by a rubbing process.

It is yet another object of the present invention to provide a liquid crystal on silicon structure that is formed of multi-domain, homeotropically aligned liquid crystals.

It is still another further object of the present invention to provide a liquid crystal on silicon structure wherein integrated spacers are formed by a silicon wafer fabrication process.

### SUMMARY OF THE INVENTION

In accordance with the present invention, a liquid crystal on silicon structure incorporating integrated spacers and silicon light valves and a method for fabricating such structure are provided.

In a preferred embodiment, a liquid crystal on silicon structure incorporating integrated spacers and silicon light valves is provided which includes a silicon substrate that has a first multiplicity of pixel electrodes formed on a top surface; a second multiplicity of integrated spacers formed of an insulating material on the top surface of the silicon substrate in-between the first multiplicity of pixel electrodes; a third multiplicity of silicon light valves formed on the top surface of the silicon substrate for orienting liquid crystal molecules; a glass substrate that is optically transparent and has an optically transparent electrode layer coated on a bottom surface positioned juxtaposed to and over the silicon substrate supported by the second multiplicity of integrated spacers to form a sealed cavity by engaging a perimeter seal surrounding the two substrates, the sealed cavity encases the optically transparent electrode layer and the third multiplicity of silicon light valves therein; and a liquid crystal material filling the sealed cavity.

The liquid crystal on silicon structure that incorporates integrated spacers and silicon light valves may further include a multiplicity of multi-domain, homeotropically aligned liquid crystal cells. The structure may further include a multiplicity of lines formed of insulating material protruding form the top surface of the silicon substrate for forming a multi-domain, homeotropically aligned liquid crystal cell, or a multiplicity of elongated recesses formed in a metal layer on the top surface of the silicon substrate for forming a fringe field homeotropically aligned liquid crystal cell. Each of the liquid crystal cell may have a square configuration with a dimension of each side between about 10 μm and about 20 μm. Each of the liquid crystal cell may have a square configuration with a distance from a neighboring pixel at between about 0.3 μm and about 2 μm the liquid crystal material that fills the sealed cavity may be a chiral-type liquid crystal. The second multiplicity of integrated spaces may be formed of silicon oxide, silicon nitride or silicon oxynitride.

In the liquid crystal on silicon structure that incorporates integrated spacers and silicon light valves, the metal layer may be formed by a metal selected from the group consisting of Al, Ag, and Al—Nd. Each of the third multiplicity of silicon light valves may be formed of a polysilicon tip and a dielectric material base. The top surface of the silicon substrate may be covered by a layer of metallic reflective film. Each of the second multiplicity of integrated spacers may have a height between about 0.5 μm and about 10 μm. Each of the third multiplicity of silicon light valves may have a height between about 0.3 μm and about 3 μm.

The present invention is further directed to a method for fabricating a liquid crystal on silicon structure with built-in integrated spacers and silicon light valves which can be carried out by the operating steps of providing a silicon substrate that has a top surface; forming a first multiplicity of pixel electrodes on the top surface; forming a second multiplicity of integrated spacers from an insulating material on the top surface of the silicon substrate in-between the first multiplicity of pixel electrodes; forming a third multiplicity of silicon light valves on the top surface of the silicon substrate for orienting liquid crystal molecules; providing a glass substrate that is optically transparent and coating an optically transparent electrode layer on a bottom surface of the glass substrate; positioning the glass substrate juxtaposed to and over the silicon substrate supported by the second multiplicity of integrated spacers and sealing a perimeter of the two substrates to form a sealed cavity therein between; and filling the sealed cavity through an inlet with a liquid crystal material.

The method for fabricating a liquid crystal on silicon structure may further include the step of forming a multiplicity of multi-domain, homeotropically aligned liquid crystal cell in-between the second multiplicity of integrated spacers, or the step of forming a multiplicity of protruded lines from an insulating material on the top surface of the silicon substrate for forming a multi-domain, homeotropically aligned liquid crystal cell. The method may further include the step of forming a multiplicity of elongated recesses in a metal layer on the top surface of the silicon substrate and forming a fringe field homeotropically aligned liquid crystal cell, or the step of forming the second multiplicity of integrated spacers by a material from the group consisting of silicon oxide, silicon nitride and silicon oxynitride. The method may further include the step of depositing the metal layer from a material that is selected from the group consisting of Al, Ag and Al—Nd. The method may further include the step of depositing a metal layer on top of the silicon substrate as a reflective coating layer.

### BRIEF DESCRIPTION OF THE DRAWINGS

These and other objects, features and advantages of the present invention will become apparent from the following detailed description and the appended drawings in which:

FIGS. 1A and 1B are graphical illustration of a conventional twisted nematic liquid crystal display cell with a voltage turned off or turned on, respectively.

FIG. 2A is a partial, cross-sectional view of a conventional liquid crystal on silicon structure that utilizes spacers applied by a spraying technique.

FIG. 2B is a graph illustrating the percent transmission of the conventional liquid crystal on silicon structure of FIG. 2A.

FIG. 3A is a conventional liquid crystal on silicon structure that has an integrated spacer formed on top for orienting the liquid crystal molecules by a rubbing process.

FIG. 3B is a partial, cross-sectional view of the conventional liquid crystal on silicon structure of FIG. 3A illustrating the reverse tilt liquid crystal molecules.

FIG. 4A is a plane view of a present invention liquid crystal on silicon structure having elongated recesses on a top surface for forming fringe field.

FIG. 4B is another embodiment of the present invention liquid crystal on silicon structure of FIG. 4A with recesses formed on top of a silicon substrate for forming fringe field.

FIG. 5A is a plane view of the present invention liquid crystal on silicon structure having elongated protrusions or lines formed on a top surface of the silicon substrate for forming multi-domain.

FIG. 5B is a plane view of another embodiment of the present invention liquid crystal on silicon structure shown in FIG. 5A.

FIG. 6 is an enlarged, cross-sectional view of the present invention liquid crystal on silicon structure illustrating an integrated spacer and a silicon light valve.

FIG. 7 is a plane view of the present invention liquid crystal on silicon structure illustrating two pixels with two integrated spacers formed therein between.

FIG. 8 is an enlarged, cross-sectional view illustrating a fabrication method for the present invention liquid crystal on silicon structure with two metal layers deposited on

FIG. 9A is a plane view of a present invention liquid crystal on silicon structure with four pixels surrounded by silicon light valves.

FIG. 9B is a cross-sectional view taken along line AA′ of FIG. 9A.

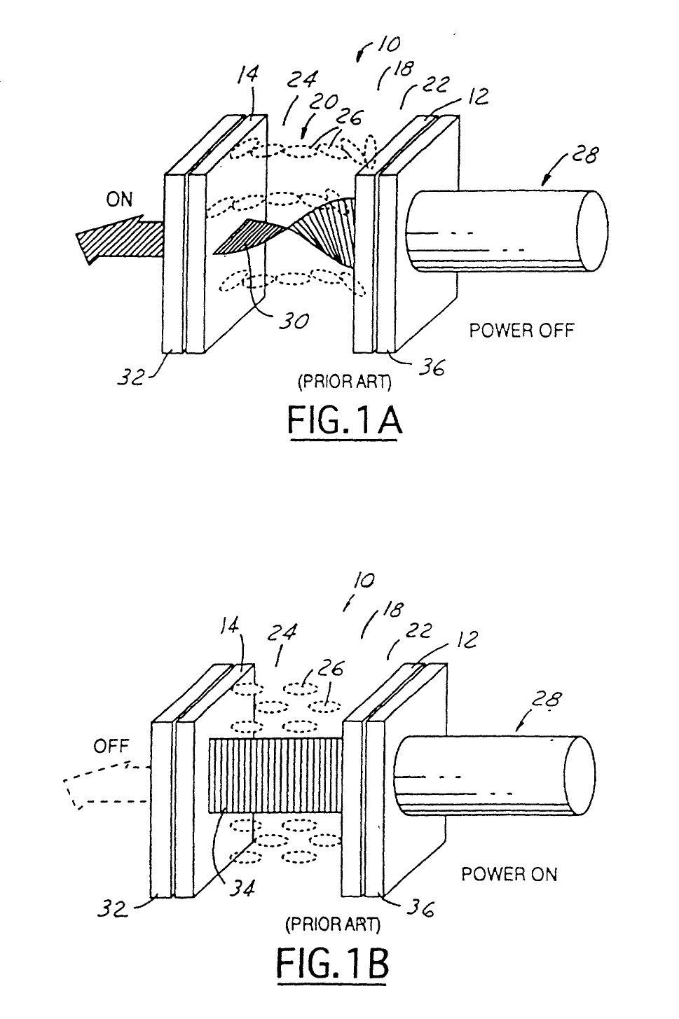

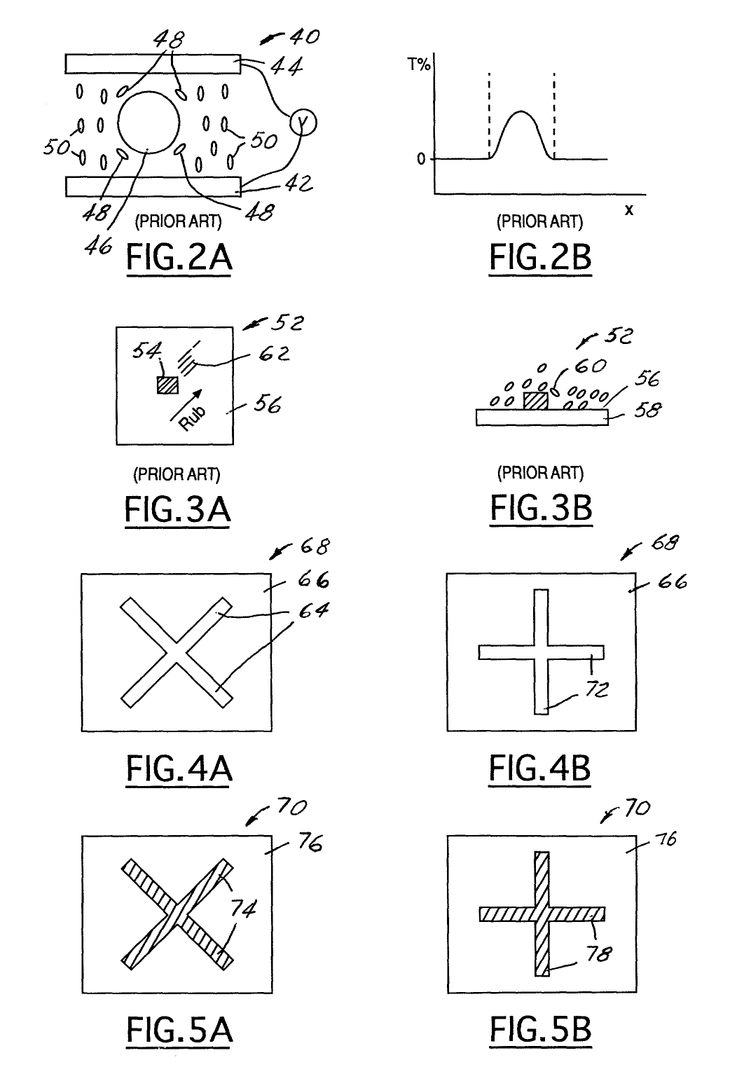

### DETAILED DESCRIPTION OF THE PREFERRED EMBODIMENT

The invention discloses liquid crystal on silicon structure that incorporates integrated spacers and silicon light valves which is constructed by the major elements of a silicon substrate, a multiplicity of integrated spacers, a glass substrate and a liquid crystal material filling a cavity formed between the silicon substrate and the glass substrate. The silicon substrate has a multiplicity of pixel electrodes formed on a top surface, while the multiplicity of integrated spacers is formed on top of the silicon substrate in-between the multiplicity of pixel electrodes. The multiplicity of silicon light valves that are formed on a top surface of the silicon substrate is used for orienting the liquid crystal molecule, such that the present invention liquid crystal does not need to be oriented by a conventional rubbing process. The glass substrate utilized in the present invention structure is optically transparent and has an optically transparent electrode layer coated on a bottom surface. The glass substrate is supported by the multiplicity of integrated spacers formed on the silicon substrate such that a sealed cavity can be formed between the two substrates by engaging a perimeter seal surrounding the substrates.

The present invention liquid crystal on silicon structure contains a multiplicity of multi-domain, homeotropically aligned liquid crystals cells. The multi-domain structure can be formed by either a multiplicity of lines or elongated protrusions formed of insulating material on a top surface of the silicon substrate, or by a multiplicity of elongated recesses formed in a metal layer on the top surface of the silicon substrate. In the present invention liquid crystal on silicon structure, each of the liquid crystal cell may have a square configuration with a dimension on each side between about 5 μm and about 20 μm, and further, each of the liquid crystal cell may have a distance to an immediate adjacent pixel at between about 0.3 μm and about 2 μm. The liquid crystal material that fills the sealed cavity may be a super-twisted nematic type or a chiral-type liquid crystal material.

The multiplicity of integrated spacers may be formed of an insulating material such as silicon oxide, silicon nitride or silicon oxynitride, while the metal layer on top of the silicon substrate may be formed of Al, Ag, or Al—Nd. Each of the multiplicity of silicon light valves may be formed of a polysilicon tip and a dielectric material base. The metal layer that covers the top surface of the silicon substrate may be a layer of a metallic reflective film. Each of the multiplicity of integrated spacer may have a height between about 2 μm and about 10 μm, and preferably about 5 μm which defines the gap between the silicon substrate and the glass substrate. The multiplicity of silicon light valves may have a height between about 0.3 μm and about 3 μm for the purpose of orienting the liquid crystal molecules. By using the present invention silicon light valves, the conventional process of rubbing the liquid crystal substrate for achieving orientation can be eliminated.

The present invention novel liquid crystal on silicon structure can be formed by either providing elongated recesses in a metal film, as shown in FIGS. 4A and 4B, or by providing elongated protrusions formed of an insulating material on top of the silicon substrate, such as that shown in FIGS. 5A and 5B. FIG. 4A illustrates two elongated recesses 64 are formed in metal film 66 coated on a silicon substrate 68. The metal film coating 66 is used as the reflective surface for the reflective type liquid crystal cell. The metal film can be suitably formed by a technique such as sputtering or evaporation. A suitable metallic material is Al, Ag, or Al—Nd. FIG. 4B shows another embodiment for the formation of the elongated recesses 72. A second method for forming the present invention multi-domain, vertically aligned (homeotropically aligned) liquid crystal cell by providing elongated protrusions 74 on a top surface 76 of a silicon substrate 70 is shown in FIG. 5A. It should be noted that in this embodiment, the elongated protrusions 74 are formed by depositing insulating materials which can be integrated into the semiconductor fabrication process. The insulating material can be suitably selected from silicon oxide, silicon nitride and silicon oxynitride or any other suitable dielectric material. FIG. 5B shows another embodiment of the elongated protrusions 78 prepared by a technique similar to that used in forming the embodiment of FIG. 5A.

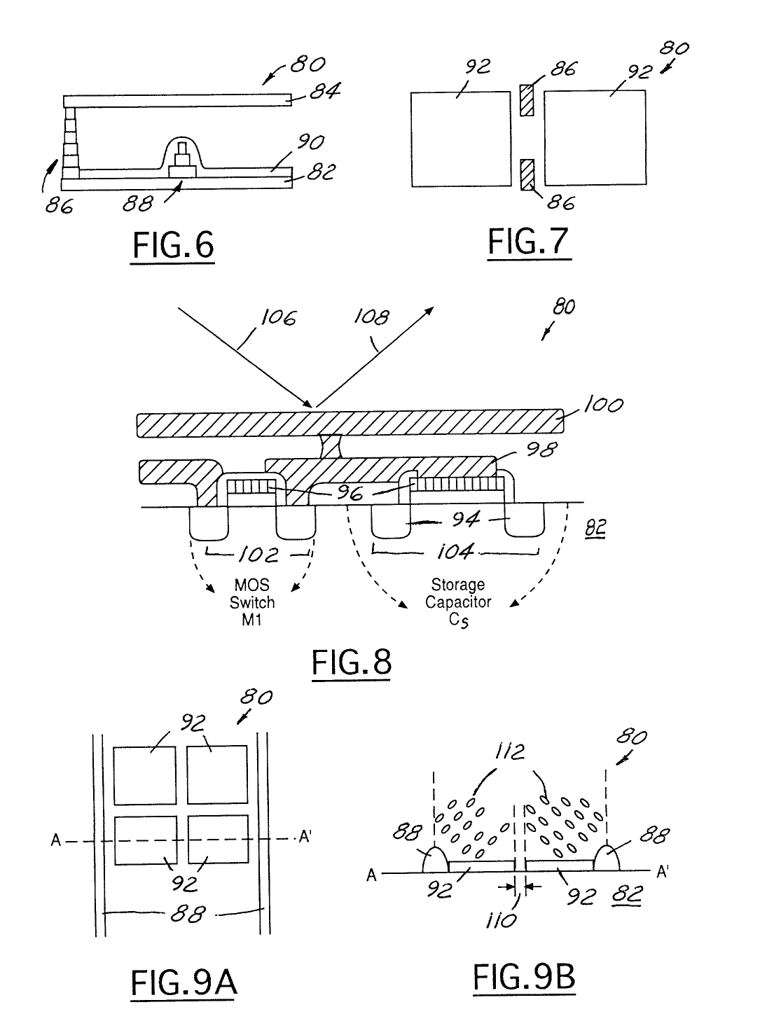

An enlarged, cross-sectional view of the present invention liquid crystal on silicon structure 80 is shown in FIG. 6. It is shown that between a silicon substrate 82 and a glass substrate 84, a multiplicity of integrated spacers 86 (only one is shown) is provided as a support and also to define the gap or spacing of the liquid crystal cell structure 80. On the bottom substrate, i.e. on the silicon substrate 82, is further formed a silicon light valve 88 by a dielectric material layer stacked with a polysilicon layer on top. Also shown in FIG. 6, for a reflective type liquid crystal cell, is a metallic reflective film 90 conformably deposited on top of the silicon substrate 82 and the silicon light valved 88, the multiplicity of integrated spacers 86 may be suitably deposited by several deposition steps in several layers in order to build up the height required i.e. between about 2 μm and about 10 μm, and preferably at about 5 μm. A plane view of the present invention liquid crystal on silicon structure 80 is shown in FIG. 7 with two pixel cells 92 and two integrated spacers is 86 therein between. The function of the silicon light valves 88 is for pre-orienting the liquid crystal molecules which is further shown in detail in FIG. 9B.

The present invention liquid crystal on silicon structure 80 is further shown in detail in FIG. 8 in an enlarged, cross-sectional view. The structure 80 shown is built on a silicon substrate 82 with source/drain regions 94, polysilicon gate 96, a metal-1 layer 98 and metal-2 layer 100. The metal-1 layer 98 is connected to data line, for a MOS device 102 formed and a storage capacitor 104 formed on the silicon substrate 82. The polysilicon gate 96 functions as the scan line for the liquid crystal on silicon structure 80. The metal-2 layer 100 functions as a reflective surface for an incident light beam 106 in producing a reflected beam 108.

For the structure 80, numerous layers of an insulating material such as SiO₂, needs to be deposited to a total thickness of between about 6000 μm and about 9000 μm. The word “about” in this writing indicates a range of value that is ±10% from the average value given. For instance, the insulating layer of SiO₂ required for the metal-1 layer 98 may be about 10,000 Å, while the insulating layer required for the metal-2 layer may be about 25,000 Å. In the process for forming the insulating layer or the passivation layer with the dielectric material, the same process can be advantageously used to form the present invention integrated spacer and the elongated protrusions on the surface of the silicon substrate.

A plane view of a present invention liquid crystal on silicon structure 80 is further shown in FIG. 9A. The structure 80 consists of four pixel elements 92 and two light valves 88 built on the outside perimeter of the four pixel elements 92. A cross-sectional view taken along line AA′ is shown in FIG. 9B. It is seen that a disclination 110 of less then 1 μm is formed between the two pixel elements 92. The liquid crystal molecules 112 are preferentially oriented by the light valves 88 divided by the disclination 110. When the disclination 110 is less than 1 μm, the quality of the liquid crystal on silicon structure is well within the acceptable limits. A preferred disclination formed by the present invention method may be between about ¼ μm and about ½ μm, or smaller than 0.5 μm.

The present invention novel method for fabricating a liquid crystal on silicon structure with built-in integrated spacers and silicon light valves can be carried out by first providing a silicon substrate that has a top surface; and then forming a first multiplicity of pixel electrodes on the top surface; forming a second multiplicity of integrated spacers from an insulating material on the top surface of the silicon substrate in-between the multiplicity of pixel electrodes; then forming a multiplicity of silicon light valves on the top surface of silicon substrate for orienting liquid crystal molecules; then providing a glass substrates that is optically transparent and coating an optically transparent electrode layer on a bottom surface of the glass substrate; then positioning the glass substrate juxtaposed to and over the silicon substrate supported by the multiplicity of integrated pacers and sealing a perimeter of the two substrates to form a sealed cavity herein; and filling the sealed cavity through an inlet with a liquid crystal material.

The present invention liquid crystal on silicon structure that incorporates integrated spacers and silicon light valves and a method for such fabrication have therefore been amply described in the above description and in the appended drawings of FIGS. 4A-9B

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A liquid crystal on silicon structure incorporating integrated spacers and silicon light valves comprising:
a silicon substrate having a first multiplicity of pixel electrodes formed on a top surface;
a second multiplicity of integrated spacers formed of an insulating material on said top surface of the silicon substrate in-between said first multiplicity of pixel electrodes;
a third multiplicity of silicon light valves formed on said top surface of the silicon substrate for orienting liquid crystal molecules;
a glass substrate that is optically transparent having an optically transparent electrode layer coated on a bottom surface positioned juxtaposed to and over said silicon substrate supported by said second multiplicity of integrated spacers forming a sealed cavity by engaging a perimeter seal surrounding said two substrates, said sealed cavity encases said optically transparent electrode layer and said third multiplicity of silicon light valves therein; and
a liquid crystal material filling said sealed cavity.

2. A liquid crystal on silicon structure incorporating integrated spacers and silicon light valves according to claim 1 further comprising a multiplicity of multi-domain homeotropically aligned liquid crystal cell.

3. A liquid crystal on silicon structure incorporating integrated spacers and silicon light valves according to claim 1 further comprising a multiplicity of lines formed of insulating material protruding from said top surface of the silicon substrate for forming a multi-domain homeotropically aligned liquid crystal cell.

4. A liquid crystal on silicon structure incorporating integrated spacers and silicon light valves according to claim 1 further comprising a multiplicity of elongated recesses formed in a metal layer on said top surface of the silicon substrate for forming a fringe field homeotropically aligned liquid crystal cell.

5. A liquid crystal on silicon structure incorporating integrated spacers and silicon light valves according to claim 2, wherein each of said liquid crystal cell having a square configuration with a dimension of each side between about 5 μm and about 20 μm.

6. A liquid crystal on silicon structure incorporating integrated spacers and silicon light valves according to claim 2, wherein each of said liquid crystal cell having a square configuration with a distance to an immediate adjacent pixel at between about 0.3 μm and about 2 μm.

7. A liquid crystal on silicon structure incorporating integrated spacers and silicon light valves according to claim 2, wherein the liquid crystal material that fills said sealed cavity being a chiral-type liquid crystal.

8. A liquid crystal on silicon structure incorporating integrated spacers and silicon light valves according to claim 1, wherein said second multiplicity of integrated spacers being formed of silicon oxide, silicon nitride or silicon oxynitride.

9. A liquid crystal on silicon structure incorporating integrated spacers and silicon light valves according to claim 4, wherein said metal layer is formed by a metal selected from the group consisting of Al, Ag and Al—Nd.

10. A liquid crystal on silicon structure incorporating integrated spacers and silicon light valves according to claim 1, wherein each of said third multiplicity of silicon light valves being formed of a polysilicon tip and a dielectric material base.

11. A liquid crystal on silicon structure incorporating integrated spacers and silicon light valves according to claim 1, wherein said top surface of the silicon substrate being covered by a layer of metallic reflective film.

12. A liquid crystal on silicon structure incorporating integrated spacers and silicon light valves according to claim 1, wherein each of said second multiplicity of integrated spacers having a height between about 0.5 μm and about 10 μm.

13. A liquid crystal on silicon structure incorporating integrated spacers and silicon light valves according to claim 1, wherein each of said third multiplicity of silicon light valves having a height between about 0.3 μm and about 3 μm.

14. A method for fabricating a liquid crystal on silicon structure with built-in integrated spacers and silicon light valves comprising the steps of:
providing a silicon substrate having a top surface;
forming a first multiplicity of pixel electrodes on said top surface;
forming a second multiplicity of integrated spacers from an insulating material on said top surface of the silicon substrate in-between the first multiplicity of pixel electrodes;
forming a third multiplicity of silicon light valves on said top surface of the silicon substrate for orienting liquid crystal molecules;
providing a glass substrate that is optically transparent and coating an optically transparent electrode layer on a bottom surface of the glass substrate;
positioning the glass substrate juxtaposed to and over said silicon substrate supported by said second multiplicity of integrated spacers and sealing a perimeter of the two substrates to form a sealed cavity therein between; and
filling the sealed cavity through an inlet a liquid crystal material.

15. A method for fabricating a liquid crystal on silicon structure with built-in integrated spacers and silicon light valves according to claim 14 further comprising the step of forming a multiplicity of multi-domain homeotropically aligned liquid crystal cell in-between said second multiplicity of integrated spacers.

16. A method for fabricating a liquid crystal on silicon structure with built-in integrated spacers and silicon light valves according to claim 14 further comprising the step of forming a multiplicity of protruded lines from an insulating material on said top surface of the silicon substrate for forming a multi-domain homeotropically aligned liquid crystal cell.

17. A method for fabricating a liquid crystal on silicon with built-in integrated spacers and silicon light valves according to claim 14 further comprising the step of forming a multiplicity of elongated recesses in a metal layer on the top surface of the silicon substrate and forming a fringe field homeotropically aligned liquid crystal cell.

18. A method for fabricating a liquid crystal on silicon with built-in integrated spacers and silicon light valves according to claim 14 further comprising the step of forming said second multiplicity of integrated spacers by a material selected from the group consisting of silicon oxide, silicon nitride and silicon oxynitride.

19. A method for fabricating a liquid crystal on silicon with built-in integrated spacers and silicon light valves according to claim 17 further comprising the step of depositing said metal layer from a material selected from the group consisting of Al, Ag and Al—Nd.

20. A method for fabricating a liquid crystal on silicon structure with built-in integrated spacers and silicon light valves according to claim 14 further comprising the step of depositing a metal layer on top of the silicon substrate as a reflective coating layer.
